(19) United States
(12) Patent Application Publication
(10) Pub. No.: US 2025/0340459 A1
(43) Pub. Date: Nov. 6, 2025

(54) PURIFICATION TREATMENT SYSTEM AND METHOD FOR FLUORINE-CONTAINING WASTEWATER

(71) Applicant: Nanjing University, Nanjing (CN)

(72) Inventors: Xiaolin Zhang, Nanjing (CN); Guangyuan Zhu, Nanjing (CN); Jingyi Chen, Nanjing (CN); Boyu Han, Nanjing (CN); Ziniu Deng, Nanjing (CN); Weiming Zhang, Nanjing (CN); Bingcai Pan, Nanjing (CN)

(73) Assignee: Nanjing University, Nanjing (CN)

(21) Appl. No.: 19/266,162

(22) Filed: Jul. 11, 2025

(51) Int. Cl. C02F 1/28; C02F 1/00; C02F 1/469; C02F 1/66; C02F 101/14; C02F 103/06

(52) U.S. Cl. CPC C02F 1/285; C02F 1/008; C02F 1/4693; C02F 1/66; C02F 2101/14; C02F 2103/06; C02F 2301/046; C02F 2301/08; C02F 2303/16

(57) ABSTRACT

A purification treatment system and method for fluorine-containing wastewater are disclosed. The purification system performs a bipolar membrane electrodialysis treatment process to obtain acid and alkaline solutions. When concentrations of the acid and alkaline solutions reach a predetermined concentration, the acid and alkaline solutions are extracted into the solution storage tanks. The extracted acid solution is mixed with the fluorine-containing wastewater to obtain acidified fluorine-containing wastewater. The acidified fluorine-containing wastewater is fed into the first mixing storage tank and performed for a deep defluorination in the first adsorption column. The extracted alkaline solution is mixed with the defluorination wastewater by utilizing the second mixer. The reacted purified water is extracted into the second adsorption column to remove hardness to obtain pure water. Excess purified water is discharged directly. The pure water is cyclically distributed into the acid chamber, the salt chamber and the alkaline chamber, to maintain volume balance.

### CROSS REFERENCE TO RELATED APPLICATION(S)

This patent application claims the priority of Chinese Patent Application No. 202410661372.2 filed on May 27, 2024, and entitled “PURIFICATION TREATMENT SYSTEM AND METHOD FOR FLUORINE-CONTAINING WASTEWATER”, the disclosure of which is incorporated by reference herein in its entirety.

### TECHNICAL FIELD

The present disclosure belongs to the field of fluorine-containing wastewater treatment, and particularly relates to a purification treatment system and method for fluorine-containing wastewater.

### BACKGROUND ART

Fluorine is a microelement necessary for maintaining normal physiological activities in the human body, and plays an important role in promoting growth and development, skeleton metabolism, and etc. Moderate intake of fluorine is beneficial to physical health, while excessive intake may lead to fluorosis. Long term intake of large amounts of fluorine may lead to dental fluorosis and skeletal fluorosis. Exposure to high levels of fluorine can even affect signaling pathways at the cellular level, thereby disrupting a dynamic balance of bone turnover and metabolism. Excessive intake of fluorine may also lead to congestive heart failure, hypertension, atherosclerosis, tendon and ligament ossification and other diseases.

Fluorine removal from drinking water can address the problem of high fluorine content in the drinking water. Researchers have conducted extensive research on technologies for fluorine removal from drinking water, including chemical precipitation, reverse osmosis, electrodialysis, ion exchange, membrane separation, adsorption, etc. A comparative analysis of several current technologies is shown in Table 1.

TABLE 1

| defluorination | | |
|---|---|---|
| technologies | advantages | disadvantages |
| precipitation | simple operations, and low cost | hard to achieve a deep defluorination, |
| method | | and sludge by-products are prone to |
| | | secondary pollution |
| reverse osmosis | has a good remove effect on fluorine and | high cost, work efficiency easy to be |
| method | some other pollutants, and no need for | distrubed, and potential health risk exist |
| | additive | |
| electrodialysis | can be controled for removing fluorine | high cost |
| method | under conditions of various of pH | |
| ion exchange | has a good effect on removing fluorine | high cost, and potential health risks exist |
| method | | |
| membrane | has a high efficiency on removing fluorine, | high cost, and potential health risks exist |
| separation method | and no need for adding chemicals | |
| activated | has a high efficiency on removing fluorine | lack of stability, and long term |
| adsorption method | | use is prone to plate failure |
| biomass | has a high efficiency on removing fluorine | poor adsorption volume and |
| adsorption method | | selectivity of materials |
| nanocomposites | has a high efficiency, easy for regenerating | at present, research is still in its infancy |
| adsorption method | and reusing, and has a large adsorption volume | |

From the table, it can be seen that traditional drinking water defluorination technologies have certain shortcomings. The precipitation method has slow sedimentation, unstable effluent quality, and presence of sludge by-products, which can easily produce secondary pollutants. Although the ion exchange method has a good defluorination effect, it has potential health risks, and the resin is easily contaminated and oxidized. A regeneration process of the ion exchange method produces a large amount of fluorine-containing waste, with a poor regeneration capacity and a high technical cost. Although the activated alumina adsorption method and the biomass adsorption method have good defluorination effects, they ultimately have certain limitations due to properties of materials themselves.

The currently popular reverse osmosis method has a high desalination rate and can effectively remove dissolved salts, colloids, microorganisms, organics, and etc. from wastewater. The concentration of fluoride is also reduced to a lower level. However, due to high-power consumption during the operation of the reverse osmosis device, the treating cost per ton of water is relatively high. Although this technology can remove fluoride from fluorine-containing wastewater, it also removes essential microelements such as potassium, calcium, sodium, magnesium, iron, and zinc for the human body. Long term use of reverse osmosis purified water as drinking water also poses health risks to residents. In addition, the treatment of a large amount of membrane concentrate produced daily is also a challenge that needs to be addressed.

Therefore, it is urgent to develop new water treatment technologies for fluorine-containing wastewater.

### SUMMARY

Objective of the present disclosure: the present disclosure provides a novel purification treatment system and method for treating fluorine-containing wastewater, which can achieve a deep defluorination process without external acid-alkaline reagents based on nanocomposites, effectively reducing the treatment cost of defluorination per ton of water.

Technical solution: a purification treatment system for fluorine-containing wastewater of the present disclosure includes:
a fluorine-containing wastewater storage tank, configured to store fluorine-containing wastewater to be purified and treated;
a bipolar membrane electrodialysis device comprising a bipolar membrane stack, an acid chamber, an alkaline chamber, a salt chamber, and an electrolyte chamber, providing an acid solution and an alkaline solution for purification of the fluorine-containing wastewater, respectively;
an acid solution storage tank, an inlet of which is connected to the acid chamber through a pipeline, providing the acid solution for the purification of the fluorine-containing wastewater;
a first mixer, connected to outlets of the fluorine-containing wastewater storage tank and the acid solution storage tank through pipelines for a mixing reaction;
a first mixing storage tank, connected to the first mixer to collect wastewater after the mixing reaction;
a first adsorption column, filled with nanocomposites, and connected to the first mixing storage tank through a pipeline to perform a deep defluorination purification for the wastewater;
an alkaline solution storage tank, an inlet of which is connected to the alkaline chamber through a pipeline, providing the alkaline solution for the purification of the fluorine-containing wastewater;
a second mixer, connected to outlets of the first adsorption column and the alkaline solution storage tank through pipelines for a mixing reaction;
a second mixing storage tank, connected to the second mixer to collect purified water after the mixing reaction, and an outfall is arranged on the second mixing storage tank;
a second adsorption column, filled with amino phosphate chelating resin to remove hardness from a portion of the purified water in the second mixing storage tank; and
a pure water storage tank, an inlet of which is connected to an outlet of the second adsorption column through a pipeline, and an outlet of which is circulated to the acid chamber, the salt chamber, and the alkaline chamber through pipelines to maintain volume balance in the acid chamber, the salt chamber, and the alkaline chamber.

In some embodiments, the acid chamber, the alkaline chamber, and the salt chamber of the system are respectively connected to the bipolar membrane stack through inlets and outlets to form a cyclic reaction.

A purification method by using the above purification treatment system of the present disclosure includes following steps:
(1) filling the acid chamber and the alkaline chamber with ultrapure water, filling the salt chamber with salt solution, filling the electrolyte chamber with sodium sulfate solution, filling the first adsorption column with nanocomposites and filling the second adsorption column with amino phosphate chelating resin;
(2) powering on the system to perform a bipolar membrane electrodialysis treatment to obtain acid and alkaline solutions;
(3) after concentration of the acid and alkaline solutions reaching a predetermined concentration, extracting the acid solution into the acid solution storage tank as needed, and mixing the extracted acid solution with fluorine-containing wastewater by utilizing the first mixer to obtain acidified fluorine-containing wastewater;
(4) feeding the acidified fluorine-containing wastewater into the first mixing storage tank and performing a deep defluorination in the first adsorption column;
(5) extracting the alkaline solution into the alkaline solution storage tank as needed, mixing the extracted alkaline solution with defluorinated wastewater and reacting to obtain purified water; and
(6) extracting the purified water after reaction into the second adsorption column as needed to remove hardness, and discharging excess purified water directly; distributing, as needed, pure water obtained from the second adsorption column to the acid chamber, the salt chamber, and the alkaline chamber circularly to maintain volume balance in the acid chamber, the salt chamber, and the alkaline chamber.

In some embodiments, the purification method of the present disclosure further includes following steps:
(7) stopping inflow when concentration of fluorine of the effluent in step (5) reaches a threshold point, and regenerating, transforming, and rinsing the nanocomposites and the phosphate amino chelating resin; and
(8) mixing regeneration solution of the nanocomposites and regeneration solution of the phosphate amino chelating resin and discharging after regenerating and transforming the nanocomposites and the phosphate amino chelating resin in step (7); and cleaning the first adsorption column and the second adsorption column with effluent after removing hardness until effluent of the first adsorption column and the second adsorption column is neutral, then refilling water and returning to step (4).

In some embodiments, in step (1) of the purification method of the present disclosure, the salt solution is a sodium chloride solution with a concentration of 1˜3 mol/L; a mass fraction of the sodium sulfate solution is 2˜5% by weight.

In some embodiments, in step (3) of the purification method of the present disclosure, the acid solution is a hydrochloric acid solution with a concentration of 0.4˜3.0 mol/L; the alkaline solution is a sodium hydroxide solution with a concentration of 0.4˜3.0 mol/L.

In some embodiments, in step (3) of the purification method of the present disclosure, pH of the acidified fluorine-containing wastewater is 2.5˜3.5.

In some embodiments, in step (4) of the purification method of the present disclosure, a flow rate of effluent of the first adsorption column is 8˜20 BV/h.

In some embodiments, in step (5) of the purification method of the present disclosure, pH of the purified water is 6˜10.

Beneficial effects: compared with existing technologies, a significant advantage of the present disclosure is that the deep purification treatment system for fluorine-containing wastewater can purify fluorine-containing wastewater based on nano adsorption, and combine bipolar membrane electrodialysis. This not only enables a deep defluorination without external acid-alkaline reagents, effectively reducing the treatment cost of defluorination per ton of water, but also forms a cyclic reaction system, enhancing stability and efficiency of the purification system.

### BRIEF DESCRIPTION OF THE DRAWINGS

FIG. 1 is a structural schematic diagram of the purification treatment system of the present disclosure.

### DETAILED DESCRIPTION OF THE EMBODIMENTS

The technical solution of the present disclosure will be further described in detail with reference to the accompanying drawings and embodiments.

It should be noted that the nanocomposites adopted in the present disclosure is an anionic resin supported nano zirconia composites, obtained from the technical solution disclosed in the prior art patent application with the publication number CN110694584B, and titled “INDUSTRIAL PREPARATION METHOD OF ANIONIC RESIN SUPPORTED NANO ZIRCONIA COMPOSITES”. In the purification step (7) of the present disclosure, inflow of water is stopped when the concentration of fluorine of the effluent reaches the threshold point, The threshold point is when the mass concentration of fluorine of the effluent is greater than 1 mg/L.

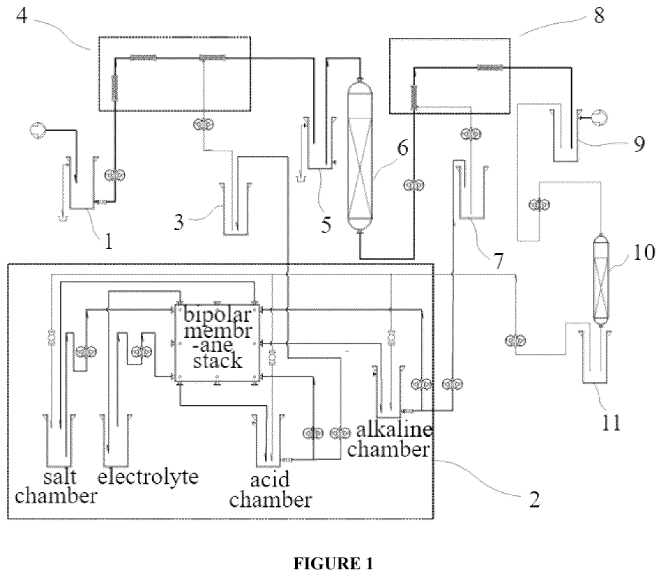

As shown in FIG. 1, the purification treatment system for fluorine-containing wastewater includes: a fluorine-containing wastewater storage tank 1, a bipolar membrane electrodialysis device 2, an acid solution storage tank 3, a first mixer 4, a first mixing storage tank 5, a first adsorption column 6, an alkaline solution storage tank 7, a second mixer 8, a second mixing storage tank 9, a second adsorption column 10 and a pure water storage tank 11. The fluorine-containing wastewater storage tank 1 is configured to store fluorine-containing wastewater to be purified and treated, an outlet is arranged on the bottom of the fluorine-containing wastewater storage tank 1. The bipolar membrane electrodialysis device 2 is configured to provide acid and alkaline solutions for a purification reaction of the fluorine-containing wastewater, respectively. The bipolar membrane electrodialysis device 2 consists of a bipolar membrane stack, an acid chamber, an alkaline chamber, a salt chamber, and an electrolyte chamber. The acid chamber, the alkaline chamber, and the salt chamber are connected to the bipolar membrane stack through inlets and outlets to form a cyclic reaction. The acid solution storage tank 3 is connected to the acid chamber through a pipeline. The first mixer 4 is connected to outlets of the acid solution storage tank 3 and the fluorine-containing wastewater storage tank 1 through pipelines for a mixing reaction. Flow rate of the acid solution can be limited by a flowmeter as actual needed. The first mixing storage tank 5 is connected to the first mixer 4 through pipelines, is configured to collect wastewater performed with an acidification reaction from the first mixer 4, and is configured to perform a deep defluorination purification by utilizing the first adsorption column 6 connected to the first mixing storage tank 5. The first adsorption column 6 is filled with nanocomposites to adsorb and remove fluorine. An outlet of the first adsorption column 6 is connected to the second mixer 8 through a pipeline, and the second mixer 8 is connected to the alkaline solution storage tank 7, thereby performing a mixing reaction to the defluorination water. An inlet of the alkaline solution storage tank 7 is connected to the alkaline chamber, providing an alkaline solution for a neutralization reaction. Purified water after the neutralization reaction is collected into the second mixing storage tank 9 connected to the second mixer 8. An outlet is arranged on the second mixing storage tank 9. The outlet may be configured to discharge the purified water. Purified water in the second mixer 8 may be extracted, as actual needed, into the second adsorption column 10 connected to the second mixer 8. The second adsorption column 10 is filled with amino phosphate chelating resin, removing hardness of the purified water. Finally, the pure water obtained in the second adsorption column 10 by adsorbing is collected into the pure water storage tank 11 connected to the second adsorption column 10. The pure water is distributed, as needed, into the acid chamber, the salt chamber and the alkaline chamber for maintaining a volume balance in the acid chamber, the salt chamber and the alkaline chamber.

In addition to necessary components mentioned above, corresponding pumps, such as peristaltic pumps, may be installed on the pipelines connected to the purification system to achieve smooth purification operations of the system.

A purification method by utilizing above purification system of the present disclosure includes follow steps.

(1) The acid chamber and the alkaline chamber are filled with ultrapure water, the salt chamber is filled with a salt solution with a concentration of 1˜3 mol/L, the electrolyte chamber is filled with a sodium sulfate solution with a mass fraction of 2˜5%, the first adsorption column is filled with nanocomposites and the second adsorption column is filled with amino phosphate chelating resin.

(2) A bipolar membrane electrodialysis treatment is performed by powering on the purification system to obtain a hydrochloric acid solution and a sodium hydroxide solution.

(3) After concentration of the hydrochloric acid solution reaches 0.4˜3.0 mol/L and concentration of the sodium hydroxide solution reaches 0.4˜3.0 mol/L, the acid solution is extracted into the acid solution storage tank as needed. The extracted acid solution is mixed with the fluorine-containing wastewater by utilizing the first mixer to obtain acidified fluorine-containing wastewater, pH of which is 2.5˜3.5.

(4) The acidified fluorine-containing wastewater is fed into the first mixing storage tank. A deep defluorination is performed in the first adsorption column. A flow rate of effluent of the first adsorption column is 8˜20 BV/h.

(5) The alkaline solution is extracted into the alkaline solution storage tank as needed. The extracted alkaline solution is mixed with defluorinated wastewater by utilizing the second mixer for a mixing reaction to obtain purified water with pH of 6˜10.

(6) The purified water after reaction is extracted into the second adsorption column as needed to remove hardness. Excess purified water may be discharged directly. Pure water obtained from the second adsorption column may be circularly distributed to the acid chamber, the salt chamber, and the alkaline chamber as needed, to maintain volume balance in the acid chamber, the salt chamber, and the alkaline chamber.

(7) Inflow is stopped when concentration of fluorine of the effluent in step S reaches a penetration point, and the nanocomposites and the phosphate amino chelating resin are regenerated, transformed and rinsed.

(8) Regeneration solution of the nanocomposites and regeneration solution of the phosphate amino chelating resin are mixed and discharged after regenerating and transforming the nanocomposites and the phosphate amino chelating resin in step (7). The first adsorption column and the second adsorption column are cleaned with the pure water after removing hardness until effluent of the first adsorption column and the second adsorption column is neutral. Then, water is refilled and returned to step (4).

### Embodiment 1

Embodiment 1 is used for purifying and treating groundwater in a rural area of Taiyuan City, Shanxi Province. Water quality before purification is shown in the table below. The groundwater in the area is treated by utilizing the above method.

TABLE 1
Component Content Table of Water Quality

| | concentration before | concentration after |
|---|---|---|
| indexes | purification (mg/L) | purification (mg/L) |
| F⁻ | 1.84 | <1 |
| Si | 9.73 | 9.45 |
| Cl⁻ | 313 | 321 |
| NO₃⁻ | 22 | 22 |
| SO₄²⁻ | 718 | 725 |
| CO₃²⁻ | 106 | 42 |
| B | 0.84 | 0.81 |
| K⁺ | 32 | 29 |
| Ca²⁺ | 269 | 259 |
| Na⁺ | 199 | 213 |
| Mg²⁺ | 74 | 67 |
| TOC | 1.56 | 1.44 |

The purification method of the Embodiment 1 specifically includes following steps.

(1) 10 pairs of bipolar membranes are arranged into the bipolar membrane stack. The acid chamber and the alkaline chamber are filled with ultrapure water with a volume of 5 L, the salt chamber is filled with a sodium chloride solution with a concentration of 2 mol/L and a volume of 5 L, the electrolyte chamber is filled with a sodium sulfate solution with a mass fraction of 5% and a volume of 5 L. The first adsorption column is filled with nanocomposites with a volume of 10 L, and the second adsorption column is filled with amino phosphate chelating resin with a volume of 10 L.

(2) A bipolar membrane electrodialysis treatment is performed by powering on the purification system to obtain a hydrochloric acid solution and a sodium hydroxide solution. The current remains constant of 1.5 A.

(3) After a period of reaction, when concentration of the hydrochloric acid solution reaches 0.6 mol/L and concentration of the sodium hydroxide solution reaches 0.6 mol/L, the hydrochloric acid solution is pumped out from the acid chamber of the bipolar membrane electrodialysis device and is mixed with the fluorine-containing wastewater and discharged.

(4) The acidified fluorine-containing wastewater is fed into the first adsorption column filled with nanocomposites for a deep defluorination.

(5) The sodium hydroxide solution is pumped out and mixed with deep-defluorinated effluent and discharged.

(6) A portion of pumped-out neutral effluent is pumped into the second adsorption column filled with the amino phosphate chelating resin for removing hardness.

(7) Hardness-removed effluent is pumped into the pure water storage tank, and then is fed into the acid chamber, the alkaline chamber and the salt chamber of the bipolar membrane electrodialysis device.

(8) Inflow is stopped when concentration of fluorine of effluent in step (5) reaches 1 mg/L, then regeneration and transform are performed on the nanocomposites and the amino phosphate chelating resin. The nanocomposites are performed for desorption regeneration by utilizing a mixture solution of NaCl and NaOH with a mass fraction of 3%, and the nanocomposites are performed for transform by utilizing a NaCl solution with a mass fraction of 3%, and a flow rate of these processes is 15 BV/h. The amino phosphate chelating resin is performed for regeneration by utilizing an HCl solution and is performed for transform by utilizing a NaOH solution, and a flow rate of these processes is 15 BV/h.

(9) Regeneration solution of the nanocomposites and regeneration solution of the phosphate amino chelating resin are mixed and discharged after regenerating and transforming the nanocomposites and the phosphate amino chelating resin in step (8). The first adsorption column and the second adsorption column are cleaned with hardness-removed effluent until effluent of the first adsorption column and the second adsorption column is neutral, a flow rate of these processes is 15 BV/h. Then, water is refilled and returned to step (4).

### Embodiment 2

Embodiment 2 is used for purifying and treating groundwater in a rural area of Taiyuan City, Shanxi Province. Water quality before purification is shown in the table below. The groundwater in the area is treated by utilizing the above method.

TABLE 2
Component Content Table of Water Quality

| | concentration before | concentration after |
|---|---|---|
| indexes | purification(mg/L) | purification (mg/L) |
| F⁻ | 3.51 | <1 |
| Si | 6.53 | 6.32 |
| Cl⁻ | 227 | 239 |
| NO₃⁻ | 27 | 31 |
| SO₄²⁻ | 563 | 580 |
| CO₃²⁻ | 92 | 43 |
| B | 0.23 | 0.19 |
| K⁺ | 57 | 62 |
| Ca²⁺ | 109 | 77 |
| Na⁺ | 354 | 340 |
| Mg²⁺ | 23 | 28 |
| TOC | 1.42 | 1.34 |

The purification method of Embodiment 2 specifically includes the following steps.

(1) 10 pairs of bipolar membranes are arranged into the bipolar membrane stack. The acid chamber and the alkaline chamber are filled with ultrapure water with a volume of 10 L, the salt chamber is filled with a sodium chloride solution with a concentration of 1.8 mol/L and a volume of 10 L, the electrolyte chamber is filled with a sodium sulfate solution with a mass fraction of 2% and a volume of 10 L. The first adsorption column is filled with nanocomposites with a volume of 30 L, and the second adsorption column is filled with amino phosphate chelating resin with a volume of 30 L.

(2) A bipolar membrane electrodialysis treatment is performed by powering on the purification system to obtain a hydrochloric acid solution and a sodium hydroxide solution. The current remains constant of 1.8 A.

(3) After a period of reaction, when concentration of the hydrochloric acid solution reaches 1.1 mol/L and concentration of the sodium hydroxide solution reaches 1.1 mol/L, the hydrochloric acid solution is pumped out from the acid chamber of the bipolar membrane electrodialysis device and is mixed with the fluorine-containing wastewater and discharged.

(4) The acidified fluorine-containing wastewater is fed into the first adsorption column filled with nanocomposites for a deep defluorination.

(5) The sodium hydroxide solution is pumped out from the alkaline chamber and mixed with deep-defluorinated effluent and discharged.

(6) A portion of pumped-out neutral effluent is pumped into the second adsorption column filled with the amino phosphate chelating resin for removing hardness.

(7) Hardness-removed effluent is pumped into the pure water storage tank, and then is fed into the acid chamber, the alkaline chamber and the salt chamber of the bipolar membrane electrodialysis device, respectively.

(8) Inflow is stopped when concentration of fluorine of effluent in step (5) reaches 1 mg/L, then regeneration and transform are performed on the nanocomposites and the amino phosphate chelating resin. The nanocomposites are performed for desorption regeneration by utilizing a mixture solution of NaCl and NaOH solutions with a mass fraction of 5% and are performed for transform by utilizing a NaCl solution with a mass fraction of 5%, and a flow rate of these processes is 10 BV/h. The amino phosphate chelating resin is performed for regeneration by utilizing a HCl solution and is performed for transform by utilizing a NaOH solution, and a flow rate of these processes is 10 BV/h.

(9) Regeneration solution of the nanocomposites and regeneration solution of the phosphate amino chelating resin are mixed and discharged after regenerating and transforming the nanocomposites and the phosphate amino chelating resin in step (8). The first adsorption column and the second adsorption column are cleaned with hardness-removed effluent until effluent of the first adsorption column and the second adsorption column is neutral, a flow rate of these processes is 10 BV/h. Then, water is refilled and returned to step (4).

### Embodiment 3

Embodiment 3 is used for purifying and treating groundwater in a rural area of Taiyuan City, Shanxi Province. Water quality before purification is shown in the table below. The groundwater in the area is treated by utilizing the above method.

TABLE 3
Component Content Table of Water Quality

| | concentration before | concentration after |
|---|---|---|
| indexes | purification (mg/L) | purification (mg/L) |
| F⁻ | 2.64 | <1 |
| Si | 4.35 | 4.21 |
| Cl⁻ | 183 | 199 |
| NO₃⁻ | 43 | 32 |
| SO₄²⁻ | 334 | 350 |
| CO₃²⁻ | 23 | 12 |
| B | 0.54 | 0.48 |
| K⁺ | 98 | 102 |
| Ca²⁺ | 128 | 98 |
| Na⁺ | 299 | 309 |
| Mg²⁺ | 43 | 48 |
| TOC | 1.87 | 1.99 |

The purification method of Embodiment 3 specifically includes the following steps.

(1) 20 pairs of bipolar membranes are arranged into the bipolar membrane stack. The acid chamber and the alkaline chamber are filled with ultrapure water with a volume of 25 L, the salt chamber is filled with a sodium chloride solution with a concentration of 1.5 mol/L and a volume of 25 L, the electrolyte chamber is filled with a sodium sulfate solution with a mass fraction of 4% and a volume of 25 L. The first adsorption column is filled with nanocomposites with a volume of 50 L, and the second adsorption column is filled with amino phosphate chelating resin with a volume of 50 L.

(2) A bipolar membrane electrodialysis treatment is performed by powering on the purification system to obtain a hydrochloric acid solution and a sodium hydroxide solution. The current remains constant of 2.0 A.

(3) After a period of reaction, when concentration of the hydrochloric acid solution reaches 1.3 mol/L and concentration of the sodium hydroxide solution reaches 1.3 mol/L, the hydrochloric acid solution is pumped out from the acid chamber of the bipolar membrane electrodialysis device and is mixed with the fluorine-containing wastewater and discharged.

(4) The acidified fluorine-containing wastewater is fed into the first adsorption column filled with nanocomposites for a deep defluorination.

(5) The sodium hydroxide solution is pumped out from the alkaline chamber and mixed with deep-defluorinated effluent and discharged.

(6) A portion of pumped-out neutral effluent is pumped into the second adsorption column filled with the amino phosphate chelating resin for removing hardness.

(7) Hardness-removed effluent is pumped into the pure water storage tank, and then is fed into the acid chamber, the alkaline chamber and the salt chamber of the bipolar membrane electrodialysis device, respectively.

(8) Inflow is stopped when concentration of fluorine of effluent in step (5) reaches 1 mg/L, then regeneration and transform are performed on the nanocomposites and the amino phosphate chelating resin. The nanocomposites are performed for desorption regeneration by utilizing a mixture solution of NaCl and NaOH solutions with a mass fraction of 8% and are performed for transform by utilizing a NaCl solution with a mass fraction of 8%, and a flow rate of these processes is 5 BV/h. The amino phosphate chelating resin is performed for regeneration by utilizing a HCl solution and is performed for transform by utilizing a NaOH solution, and a flow rate of these processes is 5 BV/h.

(9) Regeneration solution of the nanocomposites and regeneration solution of the phosphate amino chelating resin are mixed and discharged after regenerating and transforming the nanocomposites and the phosphate amino chelating resin in step (8). The first adsorption column and the second adsorption column are cleaned with hardness-removed effluent until effluent of the first adsorption column and the second adsorption column is neutral, a flow rate of these processes is 5 BV/h. Then, water is refilled and returned to step (4).

The results in Tables 1 to 3 of the above Embodiments demonstrate that the deep purification method for fluorine-containing wastewater of the present disclosure can efficiently remove fluorine from fluorine-containing wastewater with no need of external agents, and is green and pollution-free. Specific results of each stage are shown in Table 4.

TABLE 4
Process Parameters for Each Stage

| | pH of acidified | pH of neutral | |
|---|---|---|---|
| Embodiments | effluent | effluent | bed volume (BV) |
| Embodiment 1 | 2.8~3.0 | 6.1~8.2 | 3800 |
| Embodiment 2 | 2.9~3.6 | 7.0~9.3 | 3400 |
| Embodiment 3 | 3.2~3.8 | 7.5~9.5 | 3200 |

What is claimed is:

1. A purification treatment system for fluorine-containing wastewater, comprising:
a fluorine-containing wastewater storage tank (1), configured to store fluorine-containing wastewater to be purified and treated;
a bipolar membrane electrodialysis device (2), comprising a bipolar membrane stack, an acid chamber, an alkaline chamber, a salt chamber, and an electrolyte chamber, wherein the acid chamber and the alkaline chamber are configured to provide an acid solution and an alkaline solution for purification of the fluorine-containing wastewater, respectively;
an acid solution storage tank (3), an inlet of which is connected to the acid chamber through a pipeline, providing the acid solution for the purification of the fluorine-containing wastewater;
a first mixer (4), connected to outlets of the fluorine-containing wastewater storage tank (1) and the acid solution storage tank (3) through pipelines for a mixing reaction;
a first mixing storage tank (5), connected to the first mixer (4) to collect wastewater after the mixing reaction;
a first adsorption column (6), filed with nanocomposites, and connected to the first mixing storage tank (5) through a pipeline to perform a defluorination purification for the wastewater;
an alkaline solution storage tank (7), an inlet of which is connected to the alkaline chamber through a pipeline, providing the alkaline solution for the purification of the fluorine-containing wastewater;
a second mixer (8), connected to outlets of the first adsorption column (6) and the alkaline solution storage tank (7) through pipelines for a mixing reaction;
a second mixing storage tank (9), connected to the second mixer (8) to collect purified water after the mixing reaction, wherein an outfall is arranged on the second mixing storage tank (9);
a second adsorption column (10), filed with amino phosphate chelating resin to remove hardness from a portion of the purified water in the second mixing storage tank (9); and
a pure water storage tank (11), an inlet of which is connected to an outlet of the second adsorption column (10) through a pipeline, and an outlet of which is circulated to the acid chamber, the salt chamber, and the alkaline chamber through pipelines to maintain volume balance in the acid chamber, the salt chamber, and the alkaline chamber.

2. The purification treatment system for fluorine-containing wastewater according to claim 1, characterized in that the acid chamber, the alkaline chamber, and the salt chamber are respectively connected to the bipolar membrane stack through inlets and outlets to form a cyclic reaction.

3. A purification method utilizing the purification treatment system according to claim 1, comprising following steps:
(1) filling the acid chamber and the alkaline chamber with ultrapure water, filling the salt chamber with a salt solution, filling the electrolyte chamber with a sodium sulfate solution, filling the first adsorption column with nanocomposites and filling the second adsorption column with amino phosphate chelating resin;
(2) powering on the purification treatment system to perform a bipolar membrane electrodialysis treatment to obtain an acid solution and an alkaline solution;
(3) after the acid solution and the alkaline solution reach a predetermined concentration, extracting the acid solution into the acid solution storage tank (3) as needed, and mixing the extracted acid solution with fluorine-containing wastewater by utilizing the first mixer (4) to obtain acidified fluorine-containing wastewater;
(4) feeding the acidified fluorine-containing wastewater into the first mixing storage tank (5) and performing a deep defluorination in the first adsorption column (6);
(5) extracting the alkaline solution into the alkaline solution storage tank (3) as needed, mixing the extracted alkaline solution with defluorinated wastewater and reacting to obtain purified water; and
(6) extracting the purified water into the second adsorption column (10) as needed to remove hardness, and discharging excess purified water directly; distributing, as needed, pure water obtained from the second adsorption column (10) to the acid chamber, the salt chamber, and the alkaline chamber circularly to maintain volume balance in the acid chamber, the salt chamber, and the alkaline chamber.

4. The purification method according to claim 3, characterized in that the purification method further comprises following steps:
(7) stopping inflow when concentration of fluorine in effluent in step (5) reaches a threshold point, and regenerating, transforming, and rinsing the nanocomposites and the phosphate amino chelating resin; and
(8) mixing regeneration solution of the nanocomposites and regeneration solution of the phosphate amino chelating resin and discharging after regenerating and transforming the nanocomposites and the phosphate amino chelating resin in step (7); and cleaning the first adsorption column (6) and the second adsorption column (10) with effluent after removing hardness until effluent of the first adsorption column (6) and the second adsorption column (10) is neutral, then refilling water and returning to step (4).

5. The purification method according to claim 3, characterized in that in step (1), the salt solution is a sodium chloride solution with a concentration of 1˜3 mol/L; a mass fraction of the sodium sulfate solution is 2˜5% by weight.

6. The purification method according to claim 3, characterized in that in step (3), the acid solution is a hydrochloric acid solution with a concentration of 0.4˜3.0 mol/L; the alkaline solution is a sodium hydroxide solution with a concentration of 0.4˜3.0 mol/L.

7. The purification method according to claim 3, characterized in that in step (3), pH of the acidified fluorine-containing wastewater is 2.5˜3.8.

8. The purification method according to claim 3, characterized in that in step (4), a flow rate of effluent of the first adsorption column is 8˜20 BV/h.

9. The purification method according to claim 3, characterized in that in step (5), pH of the purified water is 6˜10.

10. The purification method according to claim 4, characterized in that in step (1), the salt solution is a sodium chloride solution with a concentration of 1˜3 mol/L; a mass fraction of the sodium sulfate solution is 2˜5% by weight.

11. The purification method according to claim 4, characterized in that in step (3), the acid solution is a hydrochloric acid solution with a concentration of 0.4˜3.0 mol/L; the alkaline solution is a sodium hydroxide solution with a concentration of 0.4˜3.0 mol/L.

12. The purification method according to claim 4, characterized in that in step (3), pH of the acidified fluorine-containing wastewater is 2.5˜3.8.

13. The purification method according to claim 4, characterized in that in step (4), a flow rate of effluent of the first adsorption column is 8˜20 BV/h.

14. The purification method according to claim 4, characterized in that in step (5), pH of the purified water is 6˜10.
